(19) United States
(12) Patent Application Publication
(10) Pub. No.: US 2026/0054931 A1
(43) Pub. Date: Feb. 26, 2026

(54) ORDER-PICKING ARRANGEMENT WITH INTERMEDIATE STORAGE BETWEEN PICKING ROBOTS

(71) Applicant: WÜRTH INTERNATIONAL AG, Chur (CH)

(72) Inventors: Simon DENSBORN, Neuenstein (DE); Roland SCHNEIDER, Oedheim (DE)

(21) Appl. No.: 19/104,152

(22) PCT Filed: Aug. 10, 2023
(86) PCT No.: PCT/EP2023/072235

§ 371 Date: Feb. 14, 2025

(30) Foreign Application Priority Data
Aug. 17, 2022 (DE) 10 2022 120 807.9

(51) Int. Cl. B65G 1/137; B25J 9/00; B65G 61/00

(52) U.S. Cl. CPC B65G 1/1378; B25J 9/0093; B65G 61/00

(57) ABSTRACT

Order-picking arrangement, comprising at least one first picking robot for transferring an object to be picked from at least one source container to an intermediate storage, the intermediate storage for temporarily depositing an object to be picked, and at least one second picking robot for transferring an object to be picked from the intermediate storage to at least one destination container which can receive at least one object to be picked.

### CROSS-REFERENCE TO RELATED APPLICATION

This application is a national stage application, filed under 35 U.S.C. § 371, of International Patent Application No. PCT/EP2023/072235, filed on Aug. 10, 2023, claiming priority of the German patent application DE 10 2022 120 807.9, filed on Aug. 17, 2022, both being incorporated by reference herein in its entirety.

### FIELD OF THE DISCLOSURE

The disclosure relates to an order-picking arrangement and an order-picking method.

### TECHNICAL BACKGROUND

In the conventional order-picking of objects, an order-picking person removes objects from source containers and transfers them to destination containers, for example in a logistics center of an online dealer.

In the case of an online dealer, goods from a store are packed in cartons and sent to a customer. For this purpose, the goods stored, for example, in boxes are conveyed from a storage location of the store to a worker or a robot which removes the desired number of goods from the box and places them in a shipping box which is sent to the customer. Robots used for this purpose usually use a manipulator for gripping the goods from the box, which grips goods directly from the source container and places them in the destination container, i.e. the shipping carton.

Order-picking of objects is conventionally a time-consuming matter.

It is a need of the present disclosure to provide an efficient order-picking system.

This need is met by the objects having the features according to the independent patent claims. Further exemplary embodiments are shown in the dependent claims.

### SUMMARY OF THE DISCLOSURE

According to one exemplary embodiment of the present disclosure, an order-picking arrangement is created, comprising at least one first picking robot for transferring an object to be picked from at least one source container to an intermediate storage, the intermediate storage for temporarily depositing an object to be picked, and at least one second picking robot for transferring an object to be picked from the intermediate storage to at least one destination container which can receive at least one object to be picked.

According to a further exemplary embodiment of the present disclosure, an order-picking method is provided, comprising transferring an object to be picked by means of at least one first picking robot from at least one source container to an intermediate storage for temporarily depositing an object to be picked, and subsequently transferring the object to be picked by means of at least one second picking robot from the intermediate storage to at least one destination container which receives the at least one object to be picked.

In the context of this application, the term “order-picking arrangement” is understood to mean, in particular, a system for loading destination containers with objects from source containers.

In the context of this application, the term “object” is understood to mean, in particular, a physical body which can be grasped or handled in another way, for example a merchandise element. Examples of such merchandise elements are, in particular, technical objects or components, such as, for example, tool components (for example hammer, screwdriver, etc.) or consumable components (for example screws, nails, dowels, etc.). Further examples of objects or merchandise elements to be picked are case contents, machine components, hand-held machines (for example a cordless drilling machine), tool inserts, canisters, cans, bottles, cartridges, tubes and/or drawer contents.

In the context of this application, the term “container” is understood to mean, in particular, a receiving device on and/or in which, as intended, objects such as, for example, merchandise elements are received or can be received in a receiving space. Examples of such containers are plastic containers or cartons.

In the context of this application, the term “source container” is understood to mean, in particular, a container in which an object or a plurality of objects are contained, at least one of which is intended to be transferred into an associated destination container. For example, a plurality of objects in a source container can be identical objects, for example identical merchandise elements. For example, a source container can be a merchandise box from a merchandise store. A source container can contain many objects, for example at least ten or at least hundred.

In the context of this application, the term “destination container” is understood to mean, in particular, a container which is to be filled with one or more objects. In particular, the objects transferred into a destination container can be different objects, for example different merchandise elements. For example, a destination container can be a carton which, after being loaded with ordered objects or merchandise elements, is sent to a customer. A destination container can contain many objects, for example at least ten or at least hundred.

In the context of this application, the term “picking robot” is understood to mean, in particular, a technical apparatus which can grasp, handle or manipulate objects to be order-picked in another way. A picking robot can be, for example, a robot, a cobot or a robot arm which can be designed with a manipulator for manipulating or handling objects. For example, such a manipulator of a picking robot can be used to grasp an object to be picked. In other words, a manipulator of a picking robot can be, for example, a gripper for gripping an object to be picked. A picking robot can be formed for pick-by-robot order-picking. Pick-by-robot can denote an order-picking technique for providing objects in a store with the aid of automation technology. Instead of a worker, picking robots undertake some or all of the activities in the order-picking of objects.

In the context of this application, the term “intermediate storage” is understood to mean, in particular, a receiving device for intermediate storage of objects to be order-picked after a respective object has been removed from a source container by a first picking robot on the source container side and before this object is further order-picked by a second picking robot on the destination container side. The intermediate storage can thus be formed as a buffer device for intermediate storage of order-picked objects. Therefore, the intermediate storage can be arranged between the at least one first picking robot and the at least one second picking robot and can be positioned both within range of the first picking robot and of the second picking robot. An intermediate storage can be formed to be purely passive (i.e. can only provide a static intermediate storage function). However, it is also possible to provide an actively controllable intermediate storage which can be moved dynamically, for example, or can be structurally adapted to objects currently to be picked.

### DESCRIPTION OF EXEMPLARY EMBODIMENTS

According to one exemplary embodiment of the disclosure, when order-picking objects from a source container into a destination container, firstly a first picking robot can be used for transferring a respective object from the source container to an intermediate storage for temporarily depositing said object. Then, a second picking robot can transfer said object from the intermediate storage to the destination container and thereby load the destination container with the object. Since an intermediate storage functioning as a buffer for temporarily depositing objects to be picked is provided between the source-container-side picking robot and the destination-container-side picking robot, objects to be picked do not necessarily have to be transferred from source containers into destination containers according to the “first in, first out” principle. The “first in, first out” principle can denote a logic according to which objects from source containers are handled in a specific manner. Here, objects from source containers which are fed first are also removed first again and further order-picked. Although exemplary embodiments of the disclosure can at least temporarily use the “first in, first out” principle, it is advantageously made possible, on account of the provision of an intermediate storage, to modify the order of transferring objects into a destination container with respect to the removal of the objects from a source container by buffering one or a plurality of objects in the intermediate storage before further order-picking. This makes it possible to avoid conventionally occurring dead times during order-picking in which it is necessary to wait with further order-picking because one of the components involved is not yet ready for order-picking. By providing an intermediate storage between the source-container-side and destination-container-side picking robots and within range of the source-container-side and destination-container-side picking robots, an order-picking time can be used more efficiently and a larger number of objects can be order-picked from source containers into destination containers. By providing at least one intermediate storage, it is thus possible to provide an efficient order-picking system. Advantageously, on account of the provision of the intermediate storage, the work of the second picking robot (in particular of its manipulator) for packing in the destination container can be performed independently of the arrival order of the source containers at the order-picking station.

Additional exemplary embodiments of the order-picking arrangement and of the order-picking method are described below.

According to one exemplary embodiment, the order-picking arrangement can comprise a source-container feed device for feeding the at least one source container, which contains at least one object to be picked, from a storage location to the at least one first picking robot. Correspondingly, the order-picking method can comprise feeding the at least one source container from a storage location to the at least one first picking robot. For example, the source-container feed device can be designed to feed source containers from storage shelves in such a way that the at least one first picking robot can spatially reach the fed source containers and order-pick objects accommodated therein. For example, the source-container feed device can bring about the feed of source containers to the at least one first picking robot fully automatically. The source-container feed device can be drivable by motor, and can comprise, for example, a conveyor belt, a forklift truck and/or a transport robot.

According to one exemplary embodiment, the order-picking arrangement can comprise a destination-container feed device for feeding the at least one destination container, which is to be filled with at least one object to be picked, to the at least one second picking robot. For example, the destination-container feed device can be designed to feed destination containers (for example shipping cartons) that are empty or only partially filled with objects in such a way that the at least one second picking robot can spatially reach the fed destination containers and insert objects therein. For example, the destination-container feed device can bring about the feed of destination containers to the at least one second picking robot fully automatically. The destination-container feed device can be drivable by motor, and can comprise, for example, a conveyor belt, a forklift truck and/or a transport robot.

According to one exemplary embodiment, the order-picking arrangement can comprise a source-container discharge device for discharging the at least one source container, from which at least one object to be picked has been removed, from the at least one first picking robot, in particular to a storage location or to a refilling station. If all the objects have been removed from a source container by the at least one first picking robot and if said source container is thus completely emptied, the source-container discharge device can return empty source containers to the storage location or feed them to a refilling station. The emptied source containers can then be picked up at the storage location and replaced by filled source containers. New objects can be filled into the emptied source containers at the refilling station. Thereafter, the refilled source container can be moved again to the storage location or immediately directly to the at least one first picking robot. For example, the source-container discharge device can bring about the discharge of source containers from the at least one first picking robot fully automatically. The source-container discharge device can be drivable by motor, and can comprise, for example, a conveyor belt, a forklift truck and/or a transport robot.

According to one exemplary embodiment, the order-picking arrangement can comprise a destination-container discharge device for discharging the at least one destination container, which contains at least one object to be picked, from the at least one second picking robot to a dispatch station. Correspondingly, the order-picking method can comprise discharging the at least one destination container, which is filled with at least one object, from the at least one second picking robot to a dispatch station. If all the objects have been introduced into a destination container by the at least one second picking robot and said destination container is thus completely filled, the destination-container discharge device can transfer finished order-picked destination containers to a dispatch station for dispatch to a customer. For example, the destination-container discharge device can bring about the discharge of destination containers from the at least one second picking robot fully automatically. The destination-container discharge device can be drivable by motor, and can comprise, for example, a conveyor belt, a forklift truck and/or a transport robot.

The filling of a destination container can be controlled by means of a control device in such a way that the destination container is filled with objects according to a destination-container filling list. In particular, the associated destination-container filling list can be made accessible to the picking robots for a respective destination container to be filled, with the result that the picking robots can order-pick objects between the source containers and the destination containers in a corresponding manner and, if appropriate, can buffer objects at the intermediate storage.

According to one exemplary embodiment, the order-picking arrangement can comprise the at least one source container, in particular a plurality of source containers, wherein each of the at least one source containers contains at least one object to be picked, in particular contains a plurality of objects to be picked. Different source containers can comprise different objects (in particular different merchandise types), wherein a respective source container can comprise a multiplicity of identical objects (in particular only a single merchandise type).

According to one exemplary embodiment, the order-picking arrangement can comprise the at least one destination container, in particular a plurality of destination containers, wherein each of the at least one destination containers can receive at least one object to be picked, in particular can receive a plurality of objects to be picked. Different destination containers can comprise different or identical sets of objects (in particular different merchandise types), wherein a respective destination container can comprise a multiplicity of different objects (in particular different merchandise types).

According to one exemplary embodiment, the order-picking arrangement can comprise a plurality of first picking robots, each of which is formed for transferring an object to be picked from the at least one source container to the intermediate storage. Alternatively or additionally, the order-picking arrangement can comprise a plurality of second picking robots, each of which is formed for transferring an object to be picked from the intermediate storage to the at least one destination container. Furthermore, the order-picking arrangement can comprise a plurality of intermediate storages, each of which is formed for temporarily depositing an object to be picked. Advantageously, a plurality of first or second picking robots can be provided on the source-container side and/or on the destination-container side, which picking robots can operate in parallel and/or interacting in order to transfer objects from source containers into destination containers in accordance with a destination-container filling list which is individual or uniform for different destination containers. By combining a plurality of source-container-side and a plurality of destination-container-side picking robots with a plurality of intermediate storages, a modular logistics system can be created which can process complex order-picking tasks in a highly flexible and highly efficient and highly error-resistant manner. Such an order-picking arrangement makes it possible to simultaneously serve a plurality of source containers and a plurality of destination containers and in this case to reduce or entirely eliminate dead times or waiting times during order-picking.

According to one exemplary embodiment, the intermediate storage, in particular a plurality of intermediate storages, can comprise a table-like storage surface, a shelf, a channel-shaped storage and/or a plurality of channel-shaped storages arranged in particular one above the other. Such intermediate storages can be provided with little effort and significantly improve the efficiency of the order-picking arrangement.

According to one exemplary embodiment, the intermediate storage, in particular a plurality of intermediate storages, can have such a shaping that, when depositing an object to be picked, said object assumes a well-defined position and/or orientation, in particular a tilted orientation, under the influence of gravity on the intermediate storage, in order to enable the deposited object to be gripped in a predefined manner by means of the at least one second picking robot. For example, an intermediate storage can be configured in cross section as a right-angled triangle, the right angle of which is arranged on a bottom side and is delimited by two obliquely running sides. This geometry makes it possible to allow a cuboid-shaped object to simply slide into such an intermediate storage, as a result of which the cuboid-shaped object readily moves into the bottom-side right angle. This brings the cuboid-shaped object, without additional alignment effort, into a position and orientation which enables the intermediately stored object to be gripped or grasped precisely by a second picking robot. Since many objects to be picked have an at least approximately cuboid-shaped geometry (for example cardboard packaging), the described shaping of the intermediate storage is highly advantageous for many applications.

According to one exemplary embodiment, the at least one first picking robot and/or the at least one second picking robot can be equipped, in particular selectively or automatically, with a respective one of a plurality of exchangeable manipulators with different object handling properties. For example, exchangeable grippers of different sizes and/or different gripping geometries, a suction device for holding objects under vacuum, etc. can be provided as manipulators. A respective picking robot which detects (for example by sensor means) or which is informed by means of a control device that a current picking task can be brought about better with another manipulator can automatically exchange a manipulator in order to adapt to a respective picking task. Alternatively, a manipulator of a picking robot can also be exchanged manually by a worker.

According to one exemplary embodiment, the intermediate storage, in particular a plurality of intermediate storages, can be formed to be mobile and/or exchangeable. For example, an intermediate storage between first and second picking robots can be moved out if it is unsuitable for a current picking task or another intermediate storage is better suited for this purpose. This further increases the flexibility of the order-picking arrangement.

According to one exemplary embodiment, the order-picking arrangement can comprise at least one detection device for determining detection information for monitoring and/or controlling the picking of objects by means of the order-picking arrangement. For example, such a detection device can be formed to detect weight information, position information, orientation information, optical information and/or transponder information. On the basis of detected or sensor-detected information, the order-picking arrangement, in particular the picking robots, can be controlled. For example, detection information for identifying and/or characterizing at least one object which has been transferred to at least one intermediate storage by means of the at least one first picking robot can be determined by means of the at least one detection device. Advantageously, this detection information can be fed to a second picking robot, on the basis of which the second picking robot can grip the object temporarily deposited on the intermediate storage and transfer it into a destination container. In this way, the transfer of the object from the source container via the intermediate storage into the destination container can be carried out in a particularly error-resistant manner using the first and second picking robots.

According to one exemplary embodiment, the order-picking method can comprise feeding a plurality of source containers, each of which contains at least one object to be picked, for simultaneous access by the at least one first picking robot, in particular by a plurality of first picking robots operating in parallel. Furthermore, the method can comprise selecting, by means of the at least one first picking robot, in particular by means of the plurality of first picking robots, a respective one of the fed source containers for transferring an object to be picked from the selected source container to the intermediate storage, in particular to a respectively selected one of a plurality of intermediate storages. Thus, a respective first picking robot or a control device controlling the latter can freely select from which of a plurality of source containers within its range an object is to be removed. The respective first picking robot can then transfer this object into the intermediate storage or alternatively immediately place itself in a destination container. This degree of freedom can ensure that a respective first picking robot can always or at least over a large part of its working time process an order-picking task without being subjected to waiting times (for example until feeding a suitable source container or a suitable destination container).

Particularly advantageously, the order-picking method can comprise selecting a sequence of transferring objects to be picked from the at least one first picking robot (or from the fed plurality of source containers) to the at least one intermediate storage, in particular to the plurality of intermediate storages, differently from a sequence of feeding the plurality of source containers to the at least one first picking robot, in particular to the plurality of first picking robots operating in parallel. Thus, a respective first picking robot is not necessarily subject to a “first in, first out” order-picking principle (but can use this at least temporarily). Advantageously, however, a respective first picking robot is capable of deviating at any time from a “first in, first out” order-picking principle and of order-picking source containers or the objects contained therein in a freely selectable sequence, in particular of feeding them to the intermediate storage or immediately to a destination container.

According to one exemplary embodiment, the order-picking method can comprise feeding a plurality of destination containers, each of which is provided for receiving at least one object to be picked, for simultaneous access by the at least one second picking robot, in particular by a plurality of second picking robots operating in parallel. Furthermore, the method can comprise selecting, by means of the at least one second picking robot, in particular by means of the plurality of second picking robots, a respective one of the fed destination containers for transferring an object to be picked from the intermediate storage, in particular from a respectively selected one of a plurality of intermediate storages, to the respectively selected destination container. Thus, a respective second picking robot or a control device controlling the latter can freely select into which of a plurality of destination containers within its range an object is to be introduced. The respective second picking robot can transfer this object from the intermediate storage into a respective destination container or alternatively Immediately remove itself from a source container and place it in a destination container. This degree of freedom can ensure that a respective second picking robot can always or at least over a large part of its working time process an order-picking task without being subjected to waiting times (for example until feeding a suitable source container or a suitable destination container).

Particularly advantageously, the order-picking method can comprise selecting a sequence of transferring objects to be picked from the at least one intermediate storage, in particular from the plurality of intermediate storages, differently from a sequence of transferring objects to be picked from the fed plurality of source containers to the at least one intermediate storage, in particular to the plurality of intermediate storages. Thus, a respective second picking robot is not necessarily subject to a “first in, first out” order-picking principle (but can use this at least temporarily). Advantageously, however, a respective second picking robot is capable of deviating at any time from a “first in, first out” order-picking principle and of loading destination containers in a freely selectable sequence with associated objects, in particular from the intermediate storage or immediately directly from a source container.

### BRIEF DESCRIPTION OF THE DRAWINGS

Exemplary embodiments of the present disclosure are described in detail below with reference to the following figures.

FIG. 1 shows an order-picking arrangement according to one exemplary embodiment of the disclosure.

FIG. 2 shows an order-picking arrangement according to another exemplary embodiment of the disclosure.

FIG. 3 shows an order-picking arrangement according to a further exemplary embodiment of the disclosure.

### DETAILED DESCRIPTION OF THE DRAWINGS

Identical or similar components in different figures are provided with identical reference numerals.

Before exemplary embodiments of the disclosure are described with reference to the figures, some further general aspects of the disclosure will be explained:

Conventionally, objects have to be deposited in the order in a destination container, as they arrive in source containers. This conventionally leads to a low speed of the order-picking.

According to one exemplary embodiment of the disclosure, an intermediate storage functioning as a buffer is arranged between a source-container-side picking robot and a destination-container-side picking robot, on which intermediate storage the source-container-side picking robot can, if necessary, temporarily deposit an object to be picked which, for whatever reasons, can still not be transferred from a destination-container-side picking robot into a destination container. By depositing an object in the intermediate storage which currently cannot or should not be further order-picked, the picking robots can in the meantime perform other order-picking tasks (for example order-pick another object). In this way, the resources of the picking robots for order-picking of objects can be used more efficiently by providing an intermediate storage. Thus, with an order-picking arrangement according to one exemplary embodiment of the disclosure, it is possible to order-pick a larger number of objects into destination containers in a shorter time. One advantageous aspect consists in providing an intermediate storage, designed as a buffer, for objects to be order-picked between a transfer point of source containers (for example boxes loaded with goods from a store) and a sorting point of the objects into a respective destination container, designed, for example, as a shipping carton. The objects to be order-picked can thereby be deposited independently of the order of arrival of the source containers into a destination container, because objects can be intermediately stored in the buffer. The destination-container-side picking robot for sorting the objects into the destination container can, by providing the buffer, uninterruptedly place objects in destination containers designed, for example, as shipping cartons, so that an available working time can be better used.

In one exemplary embodiment, at least one first picking robot can be provided which removes objects from a source container which has been fed to the first picking robot fully automatically from a store. At least one second picking robot can be provided in order to place the objects in a destination container. According to one preferred exemplary embodiment of the disclosure, an intermediate storage or a buffer for one or more objects is additionally provided between these two picking robots: the first picking robot removes the goods from the source container and places them in the buffer. The second picking robot removes the objects from the buffer and places them in the destination container. Since objects provided for further order-picking can always be arranged in the intermediate storage designed as a buffer, the second picking robot is always employed for sorting the objects into the destination container.

For example, in each case one or more source containers are served simultaneously. Furthermore, in each case one or more destination containers can be loaded simultaneously. The intermediate storage can preferably be formed from two or more storage places for objects.

For example, the intermediate storage can be formed as a table-like storage surface or as a shelf or as a channel-shaped storage, in particular a plurality one above the other. The channels can preferably have a square or semicircular cross section. Advantageously, objects to be picked can thereby be brought into a physically well-defined position and orientation due to their gravity when being deposited in the intermediate storage, with the result that they can be gripped in a simple manner by a second picking robot.

Objects from a source container can be order-picked into a destination container or into a plurality of destination containers. That is to say that the composition of the objects in each destination container can be selected as an arbitrary combination of objects (in particular different types) from arbitrary source containers.

Advantageously, a plurality of functionally specialized manipulators can be used on a respective first or second picking robot for different objects. When a plurality of manipulators are used, they can be loaded, for example, with different grippers. Advantageously, a respective first or second picking robot can independently change different manipulators (for example grippers of different sizes or a mechanical gripper and a vacuum suction device).

The intermediate storage can comprise different shapes adapted to different objects. The intermediate storage can be of displaceable design, such that it can be displaced or changed or exchanged.

Furthermore, a control device for controlling the order-picking method or the order-picking arrangement and its components can be provided. In the context of this application, the term “control device” is understood to mean, in particular, a device with a processor resource which is set up for controlling the order-picking arrangement, in particular by means of programming, on the basis of predefined algorithms. In order to carry out corresponding data processing, the processor resource can be equipped. The control device can be designed, for example, as a computer or processor or as a plurality of interacting computers or processors (which are spatially adjacent to one another or can be spatially separated from one another). The control device can control and coordinate all the components of the order-picking arrangement, in particular the picking robots and devices for feeding and discharging source containers and destination containers and optionally also from the intermediate storage.

Process monitoring by means of the control device (which can include, inter alia, monitoring whether the correct article has been order-picked in the correct number) can be carried out, in particular, by determining weight, by means of a scale, and/or force and moment sensors. Such process monitoring can also comprise determining a center of gravity position, for example by means of a scale, or implementing force and moment sensors. Furthermore, visual properties can be detected by means of a camera and used for process monitoring or process control. These include, in particular, detecting a QR code, a serial number, labels, patterns, barcodes, an AI (artificial intelligence)-based object classification, RFID and/or NFC tags, a three-dimensional contour, etc.

According to one exemplary embodiment of the disclosure, the objects can be checked for article defects before, during and/or after order-picking. For this purpose, data relating to the article state can be stored during the order-picking process, for example image data and/or weight data. If a complaint is made by a customer, these data can be labeled, for example, as “defective product” and can be used as a basis for training an AI unit (artificial intelligence unit) for detecting defective products.

According to one exemplary embodiment, a destination container can be monitored. If an object changes its original position or orientation, for example falls over or slips, a packing order in the destination container can be recalculated and/or the fallen-over object can be placed back into the intermediate storage and repacked into the destination container.

Furthermore, it can be checked, in particular by sensor means, whether the correct object has been gripped in the correct number from the source container. Alternatively or additionally, it can be checked, in particular by sensor means, whether the correct object has been deposited in the correct number in the destination container.

Preferably, objects to be order-picked can be gripped exactly at a predefined position and can thereby be deposited exactly at a predefined position.

According to one preferred exemplary embodiment, the intermediate storage can be designed as an inverted square pyramid, with the result that all objects (in particular cuboid-shaped objects) slip into a physically well-defined position and orientation, preferably automatically, due to their gravity when being deposited. Therefore, it is possible for the second picking robot (which can also be referred to as a packing robot) to approach the gripping point of the object extremely exactly and thereby to carry out the depositing of the object in the destination container extremely exactly.

The first picking robot (in particular its manipulator) for gripping objects from the source container can, after the completion of the picking of all objects of an order-picking task (for example of an order), seamlessly already pick objects for the next order and place them in the intermediate storage, while the second picking robot (in particular its manipulator) for packing in the destination container is still engaged with the packing of the preceding package (i.e. with the loading of a preceding destination container). If the first package or the first destination container has been completely packed, a sufficient number of objects for the second package or the second destination container are already in the intermediate storage (preferably all), with the result that the picking robot can immediately begin the packing of the second package or the second destination container in the correct order of objects.

The manipulator of a second picking robot for packing objects in a destination container can use a gripper configured for the depositing. The manipulator of a first picking robot for gripping from the source container can use a gripper configured for the picking operation from the source container.

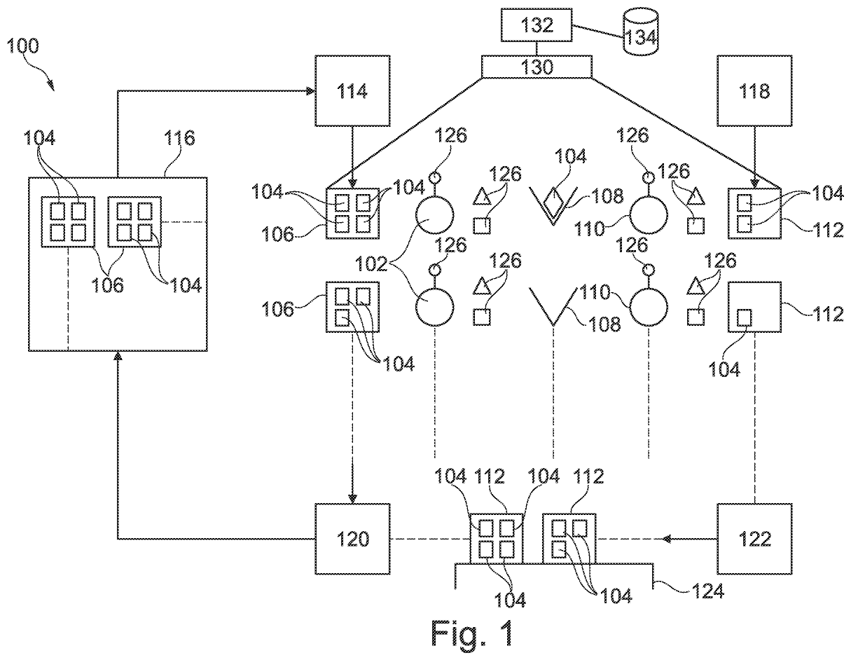

FIG. 1 shows an order-picking arrangement 100 according to one exemplary embodiment of the disclosure. For example, the order-picking arrangement 100 can be used in a logistics store of an online dealer, where ordered products (referred to below as objects 104) are intended to be filled from source containers 106 (for example plastic containers) in accordance with a respective order list into destination containers 112 (for example shipping cartons). In the case of the order-picking arrangement 100, a corresponding order-picking method is controlled by means of a control device 132 which can control all the components of the order-picking arrangement 100 which are described below. For example, the control device 132 can access a database 134 in which information with regard to order-picking tasks to be carried out (for example order lists to be processed) can be stored. It is also possible for a current merchandise inventory of the logistics store or merchandise store of the order-picking arrangement 100 to be stored in the database 134, for example information about the objects 104 currently contained in all the source containers 106.

As illustrated in FIG. 1, the order-picking arrangement 100 comprises a plurality of first picking robots 102. Each first picking robot 102 serves for transferring an object 104 to be picked from a respective source container 106 to an intermediate storage 108, which is described in more detail below, or directly to a respective destination container 112. For this purpose, an associated manipulator 126, for example a gripping device for gripping objects 104, can be mounted on each first picking robot 102. Each first picking robot 102 can then be controlled (in particular by means of the control device 132) in order to grip objects 104 in the source containers 106 and optionally deposit them on the intermediate storage 108 or deposit them directly in a suitable destination container 112.

Each of the source containers 106 can comprise a plurality of objects 104. For example, a plurality of objects 104 can be arranged in each of the source containers 104, which objects can all be assigned to an identical merchandise type (for example a pack of plastic dowels or a pack of M8 wood screws). Thus, a specific merchandise type can preferably be assigned to each source container 106. Different source containers 106 can preferably be assigned to different merchandise types. In another exemplary embodiment, a single source container 106 can also contain objects 104 of different merchandise types.

Said intermediate storage 108 likewise forms part of the order-picking arrangement 100 and functions for temporarily depositing an object 104 to be picked which has been removed from a respective one of the plurality of fed source containers 106 by a respective one of the first picking robots 102.

Furthermore, the order-picking arrangement 100 comprises a plurality of second picking robots 110 which can be operated for transferring an object 104 to be picked from the intermediate storage 108 or directly from a respective source container 106 to an associated one of a plurality of destination containers 112. For this purpose, an associated manipulator 126, for example a gripping device for gripping objects 104, can be mounted on each second picking robot 110. Each second picking robot 110 can then be controlled (in particular by means of the control device 132) in order to optionally grip objects 104 from the intermediate storage 108 or from the source containers 106 and deposit them in a suitable destination container 112.

Each of the destination containers 112 can receive a plurality of objects 104 to be picked. A set of objects 104 of different merchandise types or identical merchandise types which are intended to be introduced into an assigned destination container 112 for dispatch to an order-picker is defined in an order list stored in the database 134, which order list is assigned to a respective destination container 112. In accordance with such an order list, the objects 104 to be transferred into a respective destination container 112 can preferably be different merchandise types from different source containers 106 or identical merchandise types.

As shown in FIG. 1, the order-picking arrangement 100 comprises a source-container feed device 114 which is designed to feed the source containers 106 (each of which receives a multiplicity of objects 104 to be picked) from a storage location 116 into a range of the first picking robots 102. The storage location 116 can comprise, for example, one or more shelves, pallets or the like on which a large number of source containers 106 with objects 104 are stored. The source-container feed device 114 can bring, for example by means of a conveyor belt or a vehicle, source containers 106 required for processing order lists from the storage location 116 into the range of the first picking robots 102. The range of the first picking robots 102 is understood to mean a spatial region around the respective first picking robot 102 in which said first picking robot 102 can remove objects 104 from a source container 106 arranged there.

Furthermore, the order-picking arrangement 100 comprises a destination-container feed device 118 for feeding destination containers 112 into a range of the second picking robots 110. During the feeding to the second picking robots 110, the destination containers 102, which are to be loaded with objects 104 in accordance with an assigned order list, can be completely emptied or only partially filled. For example, the destination containers 112 can be empty shipping cartons during the feeding. The destination-container feed device 118 can bring, for example by means of a conveyor belt or a vehicle, empty destination containers 112 required for processing order lists into the range of the second picking robots 110. The range of the second picking robots 110 is understood to mean a spatial region around the respective second picking robot in which said second picking robot 110 can insert objects 104 into a destination container 112 arranged there.

Furthermore, the order-picking arrangement 100 can comprise a source-container discharge device 120 for discharging source containers 106 that are completely or partially emptied by means of the first picking robots 102 back to the storage location 116 or to a refilling station (not illustrated). The returned source containers 104 can thus be transferred back, for example, into the shelves or pallets of the storage location 116. There, the source containers 106 can be refilled with corresponding objects 104 or picked up for disposal or refilling. The source-container discharge device 120 can in turn comprise a conveyor belt, a vehicle or the like in order to move the source containers 104 to be returned.

Furthermore, the order-picking arrangement 100 can comprise a destination-container discharge device 122 for discharging destination containers 112, which are loaded with objects 104 to be picked in accordance with an assigned order list, from the second picking robots 110 to a dispatch station 124. If an order-picking task corresponding to an order list is fulfilled for a respective destination container 102, said destination container 112 can be dispatched to an order-picker at the dispatch station 124. The destination-container discharge device 122 can in turn comprise a conveyor belt, a vehicle or the like in order to move the filled destination containers 112.

As illustrated in FIG. 1, a plurality of intermediate storages 108 can be arranged in between the first picking robots 102 and the second picking robots 110, each of which is formed for temporarily depositing an object 104 to be picked. In the exemplary embodiment illustrated, each of the intermediate storages 108 has a V-shaped receiving channel into which a, for example cuboid-shaped, object 104 automatically slips into a stable end position with a predefined orientation under the influence of gravity. This simplifies subsequent gripping of an object 104 temporarily deposited in a respective intermediate storage 108 by one of the second picking robots 110. Thus, the intermediate storages 108 according to FIG. 1 are shaped, oriented and dimensioned such that, when depositing an object 104 to be picked, said object assumes a well-defined position and a tilted orientation under the influence of gravity on the intermediate storage 108, in order to enable the deposited object 104 to be gripped in a predefined manner by means of a respective second picking robot 110. The intermediate storages 108 can be formed to be mobile and can be moved away between the picking robots 102, 110 and can be replaced by other intermediate storages 108. In this way, the intermediate storages 108 can be adapted as required to objects 104 currently to be picked.

As illustrated schematically in FIG. 1, each first picking robot 102 and each second picking robot 110 is equipped with a plurality of exchangeable manipulators 126, each of which brings about a different object gripping property. For example, the preferably automatically exchangeable manipulators 126 of a respective picking robot 102, 110 can comprise grippers of different size and/or shape, vacuum suction devices, etc. Thus, each picking robot 102, 110 can also be adapted specifically to properties of the objects 104 to be picked and/or to properties of source containers 106 or destination containers 112.

The order-picking arrangement 100 can furthermore comprise one or more detection devices 130 for determining detection information for monitoring the picking of the objects 104 from the source containers 104 into the destination containers 112. In the exemplary embodiment illustrated, the detection device 130 is an optical camera which monitors the region of source containers 106, the first and second picking robots 102, 110, the intermediate storages 108 and the destination containers 112 and transmits corresponding optical detection data to the control device 132 for controlling the order-picking arrangement 100. Alternatively or additionally, a detection device 130 for detecting weight information of objects 104 and/or containers 106, 112, position information and/or orientation information of objects 104 on the intermediate storages 108 and/or transponder information of RFID tags or the like on the containers 106, 112 can also be provided. It is also possible to track the containers 106, 112 and/or the objects 104 during their processing in the order-picking arrangement 100, for example by means of transponders attached to the respective container 106, 112.

Advantageously, the plurality of first picking robots 102 can handle a plurality of source containers 106 and objects 104 removed therefrom and a plurality of intermediate storages 108 in parallel. Correspondingly, the plurality of second picking robots 110 can handle a plurality of destination containers 112 and objects 104 inserted therein and a plurality of intermediate storages 108 in parallel. Here, particularly advantageously, a sequence of the order-picking of objects from source containers 106, in intermediate storages 108, from intermediate storages 108 and in destination containers 112 can be freely selected by means of the picking robots 102, 110. As a result, in contrast to conventional approaches, it can advantageously be avoided that a picking robot 102, 110 is idle for a relatively long time, for example because such a picking robot 102, 110 still has to wait for a source container 104 or a destination container 112. By providing intermediate storages 108 which both source-container-side picking robots 102 and destination-container-side picking robots 110 can freely access in order temporarily to intermediately store objects 104 as required, idle times can be significantly reduced or even entirely avoided. This leads to a particularly efficient order-picking operation.

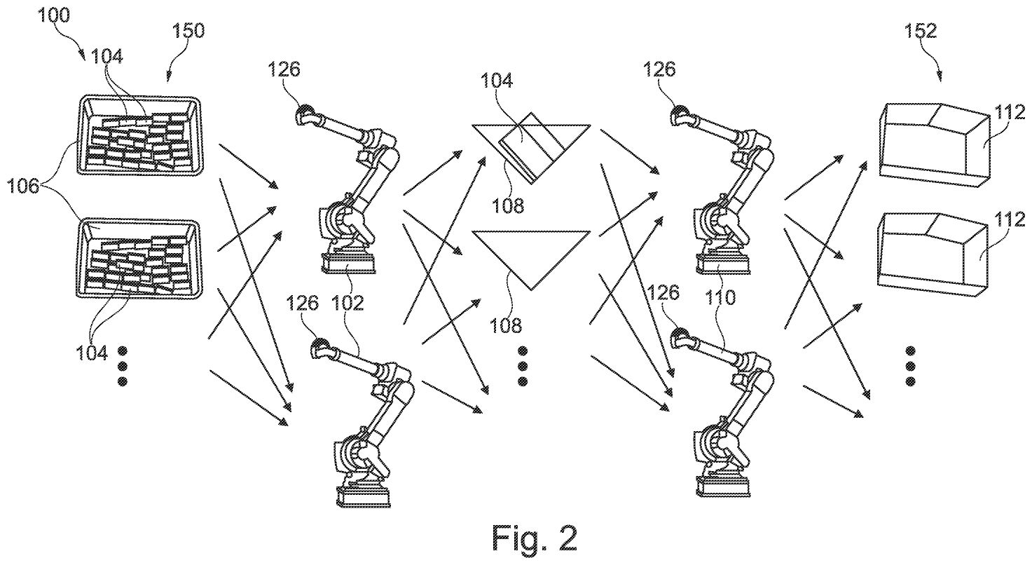

FIG. 2 shows an order-picking arrangement 100 according to another exemplary embodiment of the disclosure. In FIG. 2, some of the components which are illustrated only schematically according to FIG. 1 are illustrated with real embodiments.

At a transfer point 150 from a merchandise store, source containers 106 which are designed as plastic boxes are filled with a multiplicity of identical objects 104, for example screw packs or dowels packs. Individual objects 104 can be removed from the source containers 106 by first picking robots 102 by robot arms or other manipulators 126. The order-picking tasks of the first picking robots 102 can be coordinated or synchronized with one another by means of a control device 132 which is not illustrated in FIG. 2. Each of the first picking robots 102 has access to a plurality of serially arranged intermediate storages 108 in pyramid form, into which objects 104 to be order-picked can be temporarily deposited. Each of a plurality of second picking robots 110, which can be designed in each case as robot arms or other manipulators 126, can remove an object 104 from a respective intermediate storage 108 and insert it at a sorting point 152 into a destination container 112 which is designed here as cardboard. The order-picking tasks of the second picking robots 110 can be coordinated or synchronized with one another by means of a control device 132 which is not illustrated in FIG. 2. The order-picking tasks of the first picking robots 102 and of the second picking robots 110 can also be coordinated or Synchronized with one another by means of a control device 132 which is not Illustrated in FIG. 2. The feeding and/or discharging of the source containers 106 and/or of the destination containers 112 can be included in this coordination or synchronization.

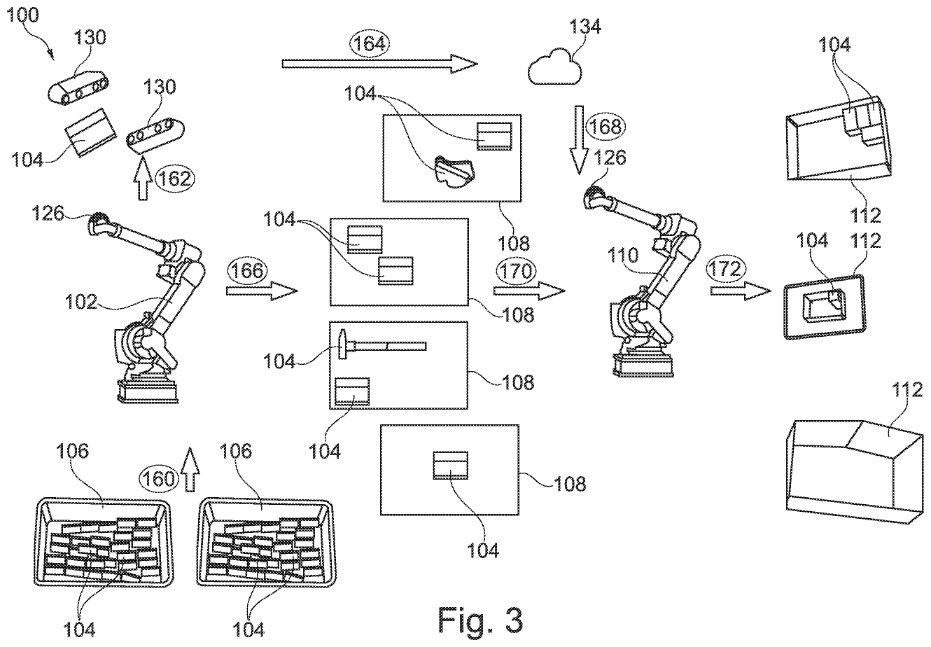

FIG. 3 shows an order-picking arrangement 100 according to a further exemplary embodiment of the disclosure. By means of the order-picking arrangement 100 according to FIG. 3, an order-picking method can be carried out, which is explained in more detail below:

As illustrated by reference numeral 160, a respective first picking robot 102 can grip one or a plurality of objects 104 from a respective one of a plurality of source containers 106.

As illustrated by reference numeral 162, detection information about the order-picking method can be determined by means of a detection device 130. In the exemplary embodiment illustrated, a removed object 104 can be characterized by sensor means, for example optically or by reading a transponder attached to the object 104.

As illustrated by reference numeral 164, the detection information can be stored in a database 134, for example in a cloud.

As illustrated by reference numeral 166, an object 104 removed from a source container 106 by means of a first picking robot 102 can be temporarily deposited at one of a plurality of storage places or intermediate storages 108.

As illustrated by reference numeral 168, the detection information stored in the database 134 relating to the object 104 removed from the source container 106 can be fed to a second picking robot 110. Clearly, the second picking robot 110 is thereby informed as to which property an object 104 which has been temporarily deposited in an intermediate storage 108 has. As a result, the second picking robot 110 is put in a position to be able to carry out gripping of the object 104 in the intermediate storage 108 correctly and precisely.

A first picking robot 102 can push the object 104 against an edge when an object 104 (for example a package) is deposited on an intermediate storage 108 (for example formed as a table) and/or a second picking robot 110 can push the object 104 against an edge when an object 104 is received from the intermediate storage 108. As a result, the object 104 can be aligned in a clear or defined manner. This makes the handling process simple and precise.

As illustrated by reference numeral 170, the second picking robot 110 can receive the object 104 temporarily deposited in the intermediate storage 108. Here, the second picking robot 110 can use the detection information which is transmitted to it and which characterizes the object 104 temporarily deposited.

As illustrated by reference numeral 172, the second picking robot 110 can load a plurality of destination containers 112 with suitable objects 104. The objects illustrated are screw packs, a hammer and safety goggles.

In addition, it should be pointed out that “comprising” does not exclude any other elements or steps and “a” or “an” does not exclude a plurality. Furthermore, it should be pointed out that features or steps which have been described with reference to one of the above exemplary embodiments can also be used in combination with other features or steps of other exemplary embodiments described above. Reference numerals in the claims should not be regarded as a restriction.

1.-23. (canceled)

24. Order-picking arrangement, comprising:
at least one first picking robot for transferring an object to be picked from at least one source container to an intermediate storage;
the intermediate storage for temporarily depositing an object to be picked; and
at least one second picking robot for transferring an object to be picked from the intermediate storage to at least one destination container which can receive at least one object to be picked.

25. Order-picking arrangement according to claim 24, comprising a source-container feed device for feeding the at least one source container, which contains at least one object to be picked, from a storage location to the at least one first picking robot.

26. Order-picking arrangement according to claim 24, comprising a destination-container feed device for feeding the at least one destination container, which is to be filled with at least one object to be picked, to the at least one second picking robot.

27. Order-picking arrangement according to claim 24, comprising a source-container discharge device for discharging the at least one source container, from which at least one object to be picked has been removed, from the at least one first picking robot to a storage location or to a refilling station.

28. Order-picking arrangement according to claim 24, comprising a destination-container discharge device for discharging the at least one destination container, which contains at least one object to be picked, from the at least one second picking robot to a dispatch station.

29. Order-picking arrangement according to claim 24, comprising the at least one source container, wherein each of the at least one source containers contains at least one object to be picked.

30. Order-picking arrangement according to claim 24, comprising the at least one destination container, wherein each of the at least one destination containers can receive at least one object to be picked.

31. Order-picking arrangement according to claim 24, comprising a plurality of first picking robots, each of which is formed for transferring an object to be picked from the at least one source container to the intermediate storage.

32. Order-picking arrangement according to claim 24, comprising a plurality of second picking robots, each of which is formed for transferring an object to be picked from the intermediate storage to the at least one destination container.

33. Order-picking arrangement according to claim 24, comprising a plurality of intermediate storages, each of which is formed for temporarily depositing an object to be picked.

34. Order-picking arrangement according to claim 24, wherein the intermediate storage comprises a table-like storage surface, a shelf, a channel-shaped storage and/or a plurality of channel-shaped storages.

35. Order-picking arrangement according to claim 24, wherein the intermediate storage has such a shaping that, when depositing an object to be picked, said object assumes a well-defined position and/or orientation under the influence of gravity on the intermediate storage, in order to enable the deposited object to be gripped in a predefined manner by means of the at least one second picking robot.

36. Order-picking arrangement according to claim 24, wherein the at least one first picking robot and/or the at least one second picking robot can be equipped with a respective one of a plurality of exchangeable manipulators with different object handling properties.

37. Order-picking arrangement according to claim 24, wherein the intermediate storage is formed to be mobile and/or exchangeable.

38. Order-picking arrangement according to claim 24, comprising at least one detection device for determining detection information for monitoring and/or controlling the picking of objects by means of the order-picking arrangement.

39. Order-picking arrangement according to claim 38, wherein the at least one detection device is formed to detect weight information, position information, orientation information, optical information and/or transponder information.

40. Order-picking method, comprising:
transferring an object to be picked by means of at least one first picking robot from at least one source container to an intermediate storage for temporarily depositing an object to be picked; and
subsequently transferring the object to be picked by means of at least one second picking robot from the intermediate storage to at least one destination container which receives the at least one object to be picked;
wherein the order-picking method preferably comprises feeding the at least one source container from a storage location to the at least one first picking robot;
wherein the order-picking method preferably comprises discharging the at least one destination container, which is filled with at least one object, from the at least one second picking robot to a dispatch station.

41. Order-picking method according to claim 40, wherein the order-picking method comprises:
feeding a plurality of source containers, each of which contains at least one object to be picked, for simultaneous access by the at least one first picking robot; and
selecting, by means of the at least one first picking robot, a respective one of the fed source containers for transferring an object to be picked from the selected source container to the intermediate storage.

42. Order-picking method according to claim 41, wherein the order-picking method comprises selecting a sequence of transferring objects to be picked from the fed plurality of source containers to the at least one intermediate storage differently from a sequence of feeding the plurality of source containers to the at least one first picking robot.

43. Order-picking method according to claim 40, wherein the order-picking method comprises:
feeding a plurality of destination containers, each of which is provided for receiving at least one object to be picked, for simultaneous access by the at least one second picking robot; and
selecting, by means of the at least one second picking robot, a respective one of the fed destination containers for transferring an object to be picked from the intermediate storage to the respectively selected destination container;
wherein the order-picking method preferably comprises selecting a sequence of transferring objects to be picked from the at least one intermediate storage differently from a sequence of transferring objects to be picked from the fed plurality of source containers to the at least one intermediate storage.
